(19) United States
(12) Patent Application Publication
(10) Pub. No.: US 2007/0112659 A1
(43) Pub. Date: May 17, 2007

(54) Method and system for generating and trading derivative investment instruments based on a covered stock portfolio benchmark index

(75) Inventors: Catherine T. Shalen, Chicago, IL (US); William Speth, Evanston, IL (US)

Correspondence Address: BRINKS HOFER GILSON & LIONE, P.O. BOX 10395, CHICAGO, IL, 60610, US

(73) Assignee: Chicago Board Options Exchange, Incorporated

(21) Appl. No.: 11/599,841

(22) Filed: Nov. 15, 2006

Related U.S. Application Data
(60) Provisional application No. 60/737,183, filed on Nov. 16, 2005.

(51) Int. Cl. G06Q 40/00

(52) U.S. Cl. 705/35

(57) ABSTRACT

A computer-readable memory containing processor executable program instructions for creating a benchmark index (XXX) is disclosed including obtaining gross daily rates of return of a covered stock index portfolio since an inception date, multiplying the cumulative product of the gross daily rates of return of the covered stock index portfolio since the inception date by a multiplier, and wherein the value of the index is calculated according to the formula
XXXₜ=XXXₜ₋₁(1+Rₜ)
where Rₜ is a daily rate of return of the covered stock index portfolio, the daily rate of return including ordinary cash dividends paid on component stocks of the index that trade ex-dividend on a date.

### RELATED APPLICATIONS

The present application claims the benefit of the filing date under 35 U.S.C. §119(e) of Provisional U.S. Patent Application Ser. No. 60/737,183, filed Nov. 16, 2005, the entirety of which is hereby incorporated herein by reference.

### TECHNICAL FIELD

The present invention relates to derivative investment markets. More particularly, the present invention relates to financial indices and derivative contracts based thereon for trading in a system of concurrent trading of securities or derivatives through both electronic and open-outcry trading mechanisms.

### BACKGROUND

A derivative is a financial security whose value is derived in part from a value or characteristic of another security, known as an underlying asset. Two exemplary, well known derivatives are options and futures.

An option is a contract giving a holder of the option a right, but not an obligation, to buy or sell an underlying asset at a specific price on or before a certain date. Generally, a party who purchases an option is referred to as the holder of the option and a party who sells an option is referred to as the writer of the option.

There are generally two types of options: call options and put options. A holder of a call option receives a right to purchase an underlying asset at a specific price, known as the “strike price,” such that if the holder exercises the call option, the writer is obligated to deliver the underlying asset to the holder at the strike price. Alternatively, the holder of a put option receives a right to sell an underlying asset at a specific price, referred to as the strike price, such that if the holder exercises the put option, the writer is obligated to purchase the underlying asset at the agreed upon strike price. Thus, the settlement process for an option involves the transfer of funds from the purchaser of the underlying asset to the seller, and the transfer of the underlying asset from the seller of the underlying asset to the purchaser. This type of settlement may be referred to as “in kind” settlement. However, an underlying asset of an option does not need to be tangible, transferable property.

Options may also be based on more abstract market indicators, such as stock indices, interest rates, futures contracts and other derivatives. In these cases, in kind settlement may not be desired, or in kind settlement may not be possible because delivering the underlying asset is not possible. Therefore, cash settlement is employed. Using cash settlement, a holder of an index call option receives the right to “purchase” not the index itself, but rather a cash amount equal to the value of the index multiplied by a multiplier such as $100. Thus, if a holder of an index call option elects to exercise the option, the writer of the option is obligated to pay the holder the difference between the current value of the index and the strike price multiplied by the multiplier. However, the holder of the index will only realize a profit if the current value of the index is greater than the strike price. If the current value of the index is less than or equal to the strike price, the option is worthless due to the fact the holder would realize a loss.

Similar to options contracts, futures contracts may also be based on abstract market indicators. A future is a contract giving a buyer of the future a right to receive delivery of an underlying commodity or asset on a fixed date in the future. Accordingly, a seller of the future contract agrees to deliver the commodity or asset on the specified date for a given price. Typically, the seller will demand a premium over the prevailing market price at the time the contract is made in order to cover the cost of carrying the commodity or asset until the delivery date.

Although futures contracts generally confer an obligation to deliver an underlying asset on a specified delivery date, the actual underlying asset need not ever change hands. Instead, futures contracts may be settled in cash such that to settle a future, the difference between a market price and a contract price is paid by one investor to the other. Again, like options, cash settlement allows futures contracts to be created based on more abstract “assets” such as market indices. Rather than requiring the delivery of a market index (a concept that has no real meaning), or delivery of the individual components that make up the index, at a set price on a given date, index futures can be settled in cash. In this case, the difference between the contract price and the price of the underlying asset (i.e., current value of market index) is exchanged between the investors to settle the contract.

Derivatives such as options and futures may be traded over-the-counter, and/or on other trading facilities such as organized exchanges. In over-the-counter transactions the individual parties to a transaction are free to customize each transaction as they see fit. With trading facility-traded derivatives, a clearing corporation stands between the holders and writers of derivatives. The clearing corporation matches buyers and sellers, and settles the trades. Thus, cash or the underlying assets are delivered, when necessary, to the clearing corporation and the clearing corporation disperses the assets as necessary as a consequence of the trades. Typically, such standard derivatives will be listed as different series expiring each month and representing a number of different incremental strike prices. The size of the increment in the strike price will be determined by the rules of the trading facility, and will typically be related to the value of the underlying asset.

While standard derivative contracts may be based on different types of market indices or statistical properties of underlying assets, there is a need for the development of additional benchmark indices as the basis for derivative contracts.

### BRIEF SUMMARY

In order to address the need for improvements in the development of additional benchmark indices as the basis for derivative contracts, a method is disclosed herein that provides for the calculation of a benchmark index.

According to a first aspect of the invention, a computer-readable memory containing processor executable program instructions for creating a benchmark index (XXX) includes obtaining gross daily rates of return of a covered stock index portfolio since an inception date, multiplying the cumulative product of the gross daily rates of return of the covered stock index portfolio since the inception date by a multiplier, and wherein the value of the index is calculated according to the formula
XXXₜ=XXXₜ₋₁(1+Rₜ)
where Rₜ is a daily rate of return of the covered stock index portfolio, the daily rate of return including ordinary cash dividends paid on component stocks of the index that trade ex-dividend on a date.

In another aspect of the invention, a computer-readable memory containing processor executable program instructions for creating a benchmark index (YYY) includes obtaining gross daily rates of return of a put protected stock index since an inception date, multiplying the cumulative product of the gross daily rates of return of the covered stock index portfolio since the inception date by a multiplier, and wherein the value of the index is calculated according to the formula:
YYYₜYYYₜ₋₁(1+Rₜ)
where Rₜ is a daily rate of return of a put protected stock index portfolio, the daily rate of return including ordinary cash dividends paid on component stocks of the index that trade ex-dividend on a date.

In yet another aspect of the invention, a computer-readable memory containing processor executable program instructions for creating a benchmark index (ZZZ) includes obtaining gross daily rates of return of a collared stock index portfolio since an inception date, multiplying the cumulative product of the gross daily rates of return of the covered stock index portfolio since the inception date by a multiplier, and wherein the value of the index is calculated according to the formula
ZZZₜ=ZZZₜ₋₁(1+Rₜ)
where Rₜ is a daily rate of return of a collared stock index portfolio, the daily rate of return including ordinary cash dividends paid on component stocks of the index that trade ex-dividend on a date.

According to another aspect, a system for creating and trading derivatives based on a benchmark index of an underlying covered stock index portfolio is described. The system includes a benchmark index module having a first processor, a first memory coupled with the first processor, and a first communications interface coupled with a communications network, the first processor, and the first memory. A dissemination module is coupled with the benchmark index module, the dissemination module having a second processor, a second memory coupled with the second processor, and a second communications interface coupled with the communications network, the second processor, and the second memory. A first set of logic is stored in the first memory and executable by the first processor to receive current values for an underlying stock index of a covered stock index portfolio benchmark derivative through the first communications interface, calculate a benchmark value for the underlying covered stock index portfolio, and pass the value for the calculated benchmark to the dissemination module. A second set of logic is stored in the second memory and executable by the second processor to receive the calculated benchmark value for the underlying covered stock index portfolio from the benchmark index module and disseminate the calculated benchmark value through the second communications interface to at least one market participant.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 is a block diagram of a system for creating and trading derivative investment instruments based on an index of financial exchanges.

FIG. 2 is a block diagram of a general computing device and network connectivity.

### DETAILED DESCRIPTION OF THE DRAWINGS AND THE PRESENTLY PREFERRED EMBODIMENTS

I. 5% OTM Covered Call Index

In an embodiment, a 5% OTM Covered Call Index (XXX) measures the total return of a passive 5% out-of-the-money covered call strategy (XXX strategy). This strategy consists of holding a stock index portfolio and selling a succession of one-month 5% out-of-the-money call options on this stock index. Each call is generally held to the open of the third Friday of the month, and a new 5% out-of-the-money call expiring in the next month is then sold, a procedure referred to as “rolling the call”. The XXX is a chained index, it is calculated daily at the close as 100 times the cumulative product of gross daily returns of a covered call strategy from the inception date of the index.

On all but roll dates, the gross daily return of the XXX strategy is calculated from the close-to-close change in the value of the covered stock index portfolio plus the aggregate value of dividends distributed by index component stocks on that date. The roll date may be, for example, the date on which the call is rolled as noted above. On roll dates, the gross daily return is compounded from three returns: (1) the return from the previous close to 11:00 a.m. EST, after the final settlement of the expiring call, (2) the return from 11:00 a.m. to 12:00 p.m. EST when the Chicago Board Options Exchange, Incorporated (CBOE) completes the calculation of half-hour volume-weighted prices for both the price of the new call sold and the stock index, and (3) the return from 12:00 p.m. EST to the close of trading. The calculation used to generate a historical series of the XXX differs slightly from the procedure above because historical intra-day volume data are not available.

The XXX is calculated by an entity, such as the CBOE once per day at the close of trading. On any given day, the XXX is calculated as follows:
XXXₜ=XXXₜ₋₁(1+Rₜ)
where Rₜ is the daily rate of return of the covered stock index portfolio. This rate includes ordinary cash dividends paid on the component stocks of the stock index that trade without a dividend, or “ex-dividend,” on that date.

On each trading day (excluding roll dates) the daily gross rate of return of the XXX equals the change in the value of the components of the covered stock index portfolio, including the value of ordinary cash dividends payable on component stocks in this index that trade “ex-dividend” on that date, as measured from the close in trading on the preceding trading day. The gross daily rate of return is equal to:
1+Rₜ=(Sₜ+Divₜ−Cₜ)/(Sₜ₋₁−Cₜ₋₁)

In the above equation, Sₜ is the closing value of the stock index at date t, Divₜ represents the ordinary cash dividends payable on the component stocks of the index that trade “ex-dividend” at date t expressed in index points, and Cₜ is the arithmetic average of the last bid and ask prices of the call option reported before 4:00 p.m. EST at date t. Sₜ₋₁ is the closing value of the stock index on the preceding trading day and Cₜ₋₁ is the average of the last bid and ask prices of the call option reported before 4:00 p.m. EST on the preceding trading day.

On roll dates, the gross daily rate of return is compounded from three gross rates of return, (1) the gross rate of return from the previous close to 11:00 a.m. EST after the determination of the Special Opening Quotation of the S&P 500 to which the expiring call is settled, (2) the gross rate of return from 11:00 a.m. to 12:00 p.m. EST when the new call option is deemed sold at the volume-weighted average price (VWAP) determined between 11:30 a.m. and 12:00 p.m. EST, and (3) the gross rate of return from 12:00 p.m. EST to the close of trading, expressed as follows:
1+Rₜ=(1+Rₐ)×(1+R_{b})×(1+R_{c})
where:
1+Rₐ=(S^{SOQ}+Divₜ−C_{Settle})/(Sₜ₋₁−Cₜ₋₁);
1+R_{b}=(S^{VWAP})/(S^{SOQ}); and
1+R_{c}=(Sₜ−Cₜ)/(S^{VWAP}−C_{VWAP})

In this equation, Rₐ is the rate of return of the covered stock index portfolio from the previous close of trading through 11:00 a.m. EST. S^{SOQ} is the Special Opening Quotation of the S&P 500. As previously defined, Divₜ represents dividends on index component stocks determined in the same manner as on non-roll dates, and C_{Settle} is the final settlement price of the expiring call option (C_{Settle}=Max[0, SOQ−K], where K is the strike price.) Sₜ₋₁ and Cₜ₋₁ are determined in the same manner as on non-roll dates.

R_{b} is the rate of return of the un-covered stock index portfolio from 11:00 a.m. to 12:00 p.m. EST. S^{VWAP} is the VWAP of the stock index based on the same time and weights used to calculate the VWAP in the new call option. R_{c} is the rate of return of the covered stock index portfolio from 12:00 p.m. EST to the close of trading on the roll date. C_{VWAP} is the volume-weighted average trading price of the new call option. EST and Cₜ refers to the average bid/ask quote of the new call option reported before 4:00 p.m. EST on the roll date.

Index Calculation for Historical Series

For the historical series, the gross daily return on roll dates is calculated as:
1+Rₜ=(1+Rₐ)×(1+R_{b})
where:
1+Rₐ=(S₁₁+Divₜ−C_{Settle})/(Sₜ₋₁−Cₜ₋₁); and
1+R_{b}=(Sₜ−Cₜ)/(S₁₁−C₁₁^{bid})

S₁₁ is the last price of the index quoted before 11:00 a.m. EST, and C^{bid}₁₁ is the last bid price of the new call option quoted before 11:00 a.m. EST.

The price of the stock index and index dividends are obtained from a market data service, such as Bloomberg, index option prices are obtained from an exchange, such as CBOE, with time and sales data that are publicly disseminated through the Option Price and Reporting System.

The most closely related index to the above-described 5% OTM Covered Call Index is the Buy-Write Index (BXM). The BXM measures the performance of a covered call strategy based on selling a monthly S&P 500 Index (SPX) call at-the-money option rather than 5% out-of-the-money option. Hence the performance and risk and return characteristics of the 5% OTM Covered Call Index differ substantially from those of the BXM.

II. Put Protected Index

In another embodiment, the Put Protected Index (YYY) measures the total return of a passive put protected strategy (YYY strategy). The YYY strategy consists of holding a stock index portfolio and buying a succession of CBOE one-month at-the-money put options on this stock index. Each put is generally held to the open of the third Friday of the month, and a new at-the-money put expiring in the next month is then bought, a procedure referred to as “rolling the put”. The YYY is also a chained index; it is calculated daily at the close as 100 times the cumulative product of gross daily returns of a put protected strategy from the inception date of the index.

On all but roll dates, the gross daily return of the YYY strategy is calculated from the close-to-close change in the value of the put protected stock index portfolio plus the aggregate value of dividends distributed by index component stocks on that date. On roll dates, the gross daily return is compounded from three returns: (1) the return from the previous close to 11:00 a.m. EST, after the final settlement of the expiring put, (2) the return from 11:00 a.m. EST to 12:00 a.m. EST when the CBOE completes the calculation of half-hour volume-weighted prices for both the price of the new put bought and the stock index, and (3) the return from 12:00 a.m. to the close of trading.

The calculation used to generate a historical series of the YYY differs slightly from the procedure above because historical intra-day volume data are not available.

The YYY is calculated by an entity, such as the CBOE, once per day at the close of trading. The YYY is a chained index, i.e., its value is equal to 100 times the cumulative product of gross daily rates of return of a put protected stock index portfolio from inception. On any given day, the YYY is calculated as follows:
YYYₜ=YYYₜ₋₁(1+Rₜ)
where Rₜ is the daily rate of return of the put protected stock index portfolio. This rate includes ordinary cash dividends paid on the component stocks of the stock index that trade “ex-dividend” on that date.

On each trading day excluding roll dates, the daily gross rate of return of the YYY equals the change in the value of the components of the covered stock index portfolio, including the value of ordinary cash dividends payable on component stocks in this index that trade “ex-dividend” on that date, as measured from the close in trading on the preceding trading day. The gross daily rate of return is equal to:
1+Rₜ=(Sₜ+Divₜ+Pₜ)/(Sₜ₋₁+Pₜ₋₁)

In this equation, Sₜ is the closing value of the stock index at date t, Divₜ represents the ordinary cash dividends payable on the component stocks of the index that trade “ex-dividend” at date t expressed in index points, and Pₜ is the arithmetic average of the last bid and ask prices of the put option reported before 4:00 p.m. EST at date t. Sₜ₋₁ is the closing value of the stock Index on the preceding trading day and Pₜ₋₁ is the average of the last bid and ask prices of the put option reported before 4:00 p.m. EST on the preceding trading day.

On roll dates, the gross daily rate of return is compounded from three gross rates of return, the gross rate of return from the previous close to 11:00 a.m. EST after the SOQ is determined and the expiring put is settled; the gross rate of return from 11:00 a.m. to 12:00 a.m. when the new put is deemed bought at the volume-weighted average price (VWAP) determined between 11:30 a.m. and 12:00 p.m. EST, and the gross rate of return from 12:00 a.m. EST to the close of trading on the roll date, expressed as follows:
1+Rₜ=(1+Rₐ)×(1+R_{b})×(1+R_{c})
where:
1+Rₐ=(S^{SOQ}+Divₜ+P_{Settle})/(Sₜ₋₁+Pₜ₋₁);
1+R_{b}=(S^{VWAP})/(S^{SOQ}); and
1+R_{c}=(Sₜ+Pₜ)/(S^{VWAP}+P_{VWAP})

In this equation, Rₐ is the rate of return of the put protected stock index portfolio from the previous close of trading through the settlement of the expiring put option. S^{SOQ} is the Special Opening Quotation used in determining the settlement price of the expiring put option. As previously defined, Divₜ represents dividends on index component stocks determined in the same manner as on non-roll dates, and P_{Settle} is the final settlement price of the expiring put option (P_{Settle}=Max[0, K−SOQ], where K is the strike price.) Sₜ₋₁ and Cₜ₋₁ are determined in the same manner as on non-roll dates.

R_{b} is the rate of return of the non-protected stock index portfolio from the settlement of the expiring option to the time the new put option is deemed bought S^{VWAP} is the VWAP of the stock index based on the same time and weights used to calculate the VWAP of the new put option.

R_{c} is the rate of return of the covered stock index portfolio from the time the new call option is deemed sold to the close of trading on the roll date. P_{VWAP} is the volume-weighted average trading price of the new put option between 11:30 a.m. and 12:00 p.m. EST and Cₜ refers to the average bid/ask quote of the new put option reported before 4:00 p.m. EST on the roll date.

Index Calculation for Historical Series

For the historical series, the gross daily return on roll dates was calculated as
1+Rₜ=(1+Rₐ)×(1+R_{b})
where:
1+Rₐ=(S₁₁+Divₜ+P_{Settle})/(Sₜ₋₁+Pₜ₋₁); and
1+R_{b}=(Sₜ+Pₜ)/(S₁₁+P₁₁^{ask})

S₁₁ is the last price of the index quoted before 11:00 a.m., and P^{ask}₁₁ is the last ask price of the new put option quoted before 11:00 a.m.

The price of the stock index and index dividends are obtained from a market data service, such as Bloomberg, index option prices are obtained from an exchange, such as CBOE, with time and sales data that are publicly disseminated through the Option Price and Reporting System.

III. Collar Index

In still another embodiment, the Collar Index (ZZZ) measures the total return of a passive collar strategy (ZZZ strategy). This strategy consists of holding a stock index portfolio, buying a succession of one-month 5% out-of-the-money put options on this stock index, while also selling a succession of one-month 5% out-of-the-money call options on the stock index. The put and call are generally held to the open of the third Friday of the month, and a new 5% out-of-the-money put as well as a new 5% out-of-the-money call expiring in the next month are bought and sold respectively, a procedure referred to as “rolling the collar”. The ZZZ is a chained index; it is calculated daily at the close as 100 times the cumulative product of gross daily returns of this put protected strategy since the inception date of the index.

On all but roll dates, the gross daily return of the ZZZ strategy is calculated from the close-to-close change in the value of the put protected stock index portfolio plus the aggregate value of dividends distributed by index component stocks on that date. On roll dates, the gross daily return is compounded from three returns: (1) the return from the previous close to 11:00 a.m. EST, after the final settlement of the expiring put and call, (2) the return from 11:00 a.m. to 12:00 p.m. EST when the CBOE completes the calculation of half-hour volume-weighted prices of the new put and call and of the stock index, and (3) the return from 12:00 p.m. EST to the close of trading.

The calculation used to generate a historical series of the ZZZ differs slightly from the procedure above because historical intra-day volume data are not available.

The ZZZ is calculated once per day at the close of trading. The ZZZ is a chained index, i.e., its value is equal to 100 times the cumulative product of gross daily rates of return of a collared stock index portfolio from inception. On any given day, the ZZZ is calculated as follows:
ZZZₜ=ZZZₜ₋₁(1+Rₜ)
where Rₜ is the daily rate of return of the collared stock index portfolio. This rate includes ordinary cash dividends paid on the component stocks of the stock index that trade “ex-dividend” on that date.

On each trading day excluding roll dates, the daily gross rate of return of the ZZZ equals the change in the value of the components of the collared stock index portfolio, including the value of ordinary cash dividends payable on component stocks in this index that trade “ex-dividend” on that date, as measured from the close in trading on the preceding trading day. The gross daily rate of return is equal to:
1+Rₜ=(Sₜ+Divₜ+Pₜ−Cₜ)/(Sₜ₋₁+Pₜ₋₁−Cₜ₋₁)

In this equation, Sₜ is the closing value of the stock index at date t, Divₜ represents the ordinary cash dividends payable on the component stocks of the index that trade “ex-dividend” at date t expressed in index points, and Pₜ and Cₜ are the arithmetic averages of the last bid and ask prices of the put and call options reported before 4:00 p.m. EST at date t. Sₜ₋₁ is the closing value of the stock index on the preceding trading day and Pₜ₋₁ and Cₜ₋₁ are the averages of the last bid and ask prices of the put and call options reported before 4:00 p.m. EST on the preceding trading day.

On roll dates, the gross daily rate of return is compounded from three gross rates of return, (1) the gross rate of return from the previous close to 11:00 a.m. EST after the determination of the Special Opening Quotation of the S&P 500 to which the expiring put and call are settled, (2) the gross rate of return from 11:00 a.m. to 12:00 p.m. EST when the new put and call positions are deemed bought and sold respectively at the volume-weighted average prices (VWAP) determined between 11:30 a.m. and 12:00 p.m. EST, and (3) the gross rate of return from 12:00 p.m. EST to the close of trading on the roll date, expressed as follows:
1+Rₜ=(1+Rₐ)×(1+R_{b})×(1+R_{c})
where:
1+Rₐ=(S^{SOQ}+Divₜ+P_{Settle}−Cₛₑₜₜₗₑ)/(Sₜ₋₁+Pₜ₋₁−Cₜ₋₁);
1+R_{b}=(S^{VWAP})/(S^{SOQ}); and
1+R_{c}=(Sₜ+Pₜ−Cₜ)/(S^{VWAP}+P_{VWAP}−C_{VWAP})

In this equation, Rₐ is the rate of return of the collared stock index portfolio from the previous close of trading to 11:00 a.m. EST. S^{SOQ} is the Special Opening Quotation of the S&P 500. As previously defined, Divₜ represents dividends on index component stocks determined in the same manner as on non-roll dates, and Pₛₑₜₜₗₑ and C_{Settle} are the final settlement prices of the expiring put and call options (P_{Settle}=Max[0, K−SOQ], and Cₛₑₜₜₗₑ=Max[0, SOQ−K] where K is the strike price) Sₜ₋₁, Pₜ₋₁ and Cₜ₋₁ are determined in the same manner as on non-roll dates.

R_{b} is the rate of return of the stock index portfolio from the settlement of the expiring option to the time the new put and call options are deemed bought and sold, S^{VWAP} is the volume-weighted average value of the stock index based on the same time and weights used to calculate the VWAP of the new call and put options.

R_{c} is the rate of return of the collared stock index portfolio from the time the new put and call options are deemed bought and sold to the close of trading on the roll date. As defined above, S^{VWAP} is the volume-weighted average value of the stock index based on the combined times and volumes used to calculate the VWAP of the new put and call options. P_{VWAP} and C_{vwap} are the VWAPs of the new put and call options between 11:30 a.m. and 12:00 p.m. EST and Pₜ and Cₜ refers to the average bid/ask quote of the new put and call options reported before 4:00 p.m. EST on the roll date.

The price of the stock index and index dividends are obtained from a market data service, such as Bloomberg, index option prices are obtained from an exchange, such as CBOE, with time and sales data that are publicly disseminated through the Option Price and Reporting System.

Index Calculation for Historical Series

For the historical series, the gross daily return on roll dates is calculated as
1+Rₜ=(1+Rₐ)×(1+R_{b})
where:
1+Rₐ=(S₁₁+Divₜ+P_{Settle}−C_{Settle})/(Sₜ₋₁+Pₜ₋₁−Cₜ₋₁); and
1+R_{b}=(Sₜ+Pₜ−Cₜ)/(S₁₀+P₁₁^{ask}−C₁₁^{bid})

S₁₁ is the last price of the index quoted before 11:00 am EST, P^{ask}₁₁ is the last ask price of the new put option and C^{bid}₁₁ the last bid price of the new call option quoted before 11:00 a.m. EST.

By way of additional exemplary embodiments, compositions of portfolios may be expressed as:

Short 1 Month Straddle

Sell $100 worth of following option package: one At-The-Money (ATM) call and one ATM put (defined in accordance with the CBOE S&P 500 BuyWrite Index (BXM), described in detail in U.S. Published patent application No. 20030225658, incorporated by reference herein). Based on 10 ATM S&P 500 reference price (closing price prior to Nov. 20, 1992), find the closest call strike at or above this price and closest put price at or below this price. Since call and put strikes are not always equal, technically this can be considered as a strangle.

Short 1 month 5% Out-Of-The-Money (OTM) Strangle, analogous to the ATM strangle, but the call is the closest strike at or above 1.05×reference price and the put is closest strike at or below 0.95×S&P 500 reference price.

Short 1 month Bull Spread Sell $100 worth of following option package=long one ATM call and short one 5% OTM call. Strikes selected using the same rule as for BXM so closest strike at or above the reference price for the long call, and at or above 1.05×reference price for the short call.

Short 1 month Bear Spread Sell $100 worth of following option package—long one ATM put and short one 5% OTM put.

Additional option-based benchmarks have been developed. These benchmarks fall into two categories:

(1) Structured Index Benchmarks

Structured Index Benchmarks are preferably based on overlaying options which are based on the S&P 500 Index (SPX), known as SPX options, over a portfolio of the S&P 500, and calculated using the same methodology as used for BXM (described in detail in U.S. Published patent application No. 20030225658, discussed herein above). In an embodiment in accordance with the principles of the present invention, an index is designed to reflect on a portfolio that invests in Standard & Poor's 500 Index stocks that also sells S&P 500 index covered call options (ticker symbol “SPX”). The S&P 500 index is disseminated by Standard & Poor's, 55 Water Street, New York, N.Y. 10041 (“S&P”). S&P 500 index options are offered by the Chicago Board Options Exchange, Incorporated., 400 South LaSalle Street, Chicago, Ill. 60605. In an alternative embodiment, an index could be designed to reflect on a portfolio that invests in Dow Jones Industrials Index stocks that also sells Dow Jones Industrials index covered call options (DJX). The Dow Jones Industrials index is disseminated by Dow Jones & Company Dow Jones Indexes, P.O. Box 300, Princeton, N.J. 08543-0300. Dow Jones Industrials index options are also offered by the Chicago Board Options Exchange, Incorporated. In further alternative embodiments, indices could be designed to reflect on a portfolio that invests in NASDAQ-100 (NDX) stocks or any other equity index that also sells NASDAQ or any other equity index covered call options. By way of example:

SPX 1 Month Covered Calls 2% and 5% OTM

SPX 3 Months Covered Calls ATM and 5% OTM

SPX 1 Month Protected Puts ATM and 5% OTM

SPX 3 Months Protected Puts ATM and 5% OTM

SPX ATM −5% OTM Collars 1 and 3 Months

(2) Option Strategy Benchmarks

Option Strategy Benchmarks follow the performance of pure option strategies (no S&P 500 investment). The following is a method of calculation for these option benchmarks wherein each index tracks the cumulative profit and loss generated by selling $100 worth of the option portfolio at every monthly roll date:

SPX Short 1 Month Straddle

SPX Short 1 Month 5% OTM Strangle

SPX Short 1 Month Bull Spread (ATM −5% OTM)

SPX Short 1 Month Bear Spread (ATM −5% OTM)

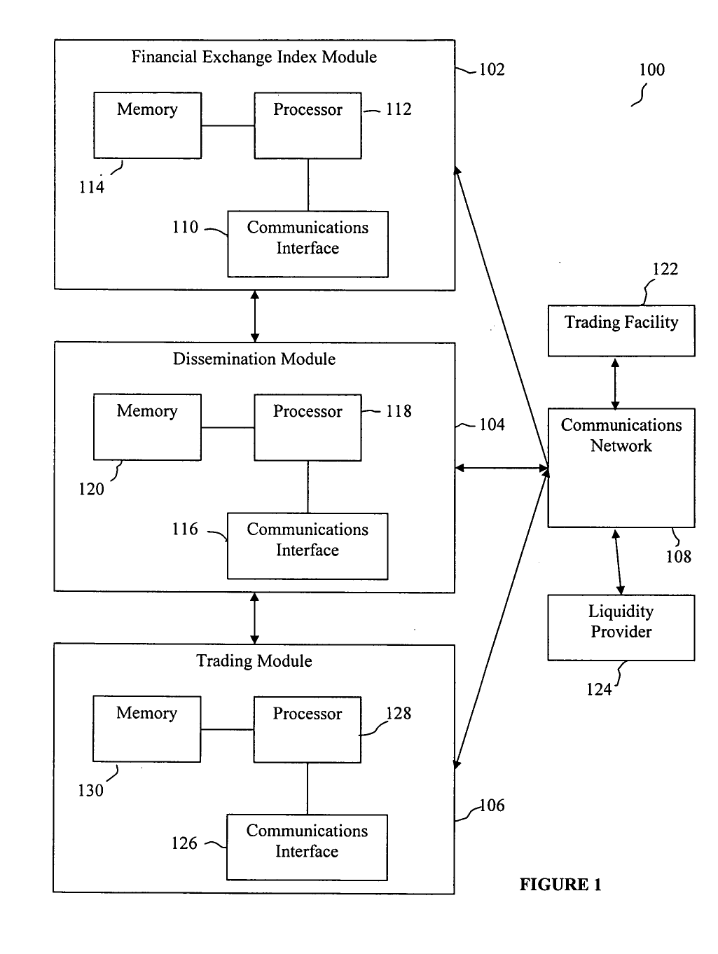

The embodiments disclosed herein can be created through the use a computer-readable memory containing processor executable program instructions. As illustrated in FIG. 1, a block diagram of a system 100 is shown for creating and trading derivative investment instruments based on a benchmark index. Generally, the system comprises a financial exchange index module 102, a dissemination module 104 coupled with the financial exchange index module 102, and a trading module 106 coupled with the dissemination module 104. Typically, each module 102, 104, 106 is also coupled to a communication network 108 coupled to various trading facilities 122 and liquidity providers 124.

The financial exchange index module 102 comprises a communications interface 110, a processor 112 coupled with the communications interface 110, and a memory 114 coupled with the processor 112. Logic stored in the memory 114 is executed by the processor 112 such that that the financial exchange index module 102 may receive a first set of trade information for each security representative of a desired group of securities and futures exchanges through the communications interface 110, aggregate that first set of trade information over a first time period, calculate an index for the desired group of exchanges with the aggregated first set of trade information, and a standardized measure of the index, as described above; and pass the calculated values to the dissemination module 104.

The dissemination module 104 comprises a communications interface 116, a processor 118 coupled with the communications interface 116, and a memory 120 coupled with the processor 118. Logic stored in the memory 120 is executed by the processor 118 such that the dissemination module 104 may receive the calculated values from the financial exchange index module 102 through the communications interface 116, and disseminate the calculated values over the communications network 108 to various trading facilities 122, liquidity providers 124 and other market participants.

The trading module 106 comprises a communications interface 126, a processor 128 coupled with the communications interface 126, and a memory 130 coupled with the processor 128. Logic stored in the memory 130 is executed by the processor 128 such that the trading module 106 may receive buy or sell orders over the communications network 108, as described above, and pass the results of the buy or sell order to the dissemination module 104 to be disseminated over the communications network 108 to the market participants.

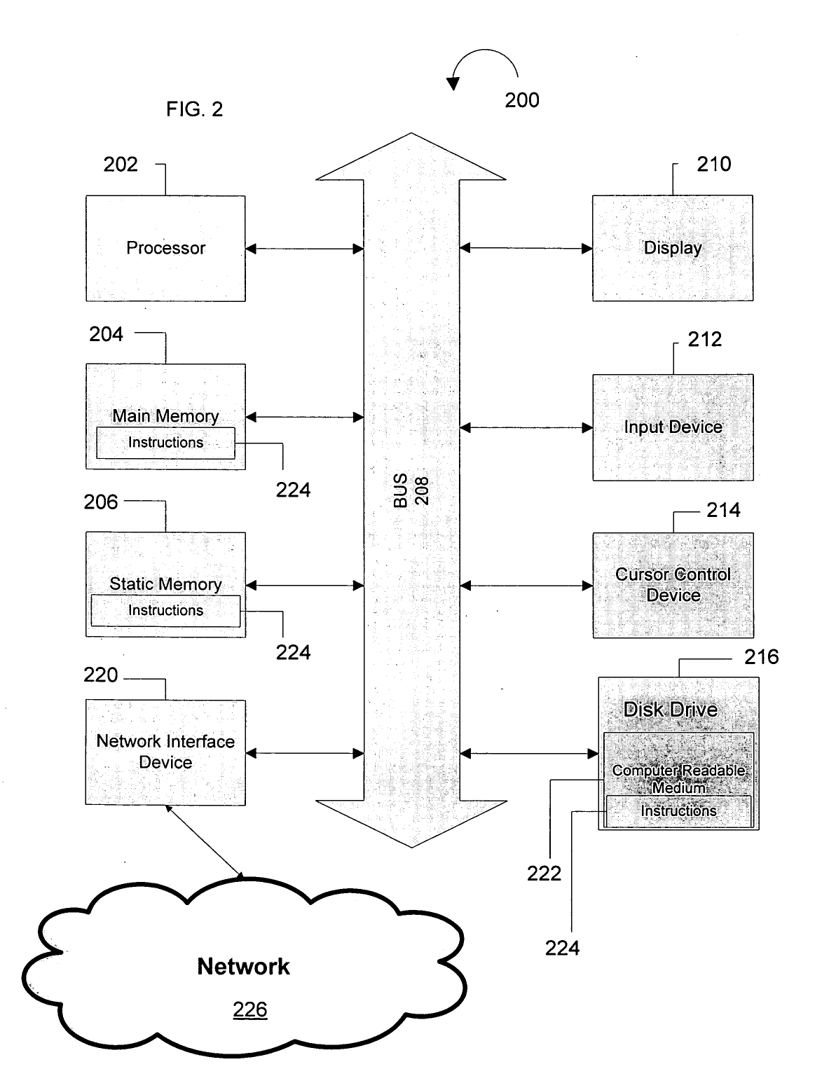

Referring to FIG. 2, an illustrative embodiment of a general computer system that may be used for one or more of the components shown in FIG. 1, or in any other trading system configured to carry out the methods discussed above, is shown and is designated 200. The computer system 200 can include a set of instructions that can be executed to cause the computer system 200 to perform any one or more of the methods or computer based functions disclosed herein. The computer system 200 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 200 can also be implemented as or incorporated into various devices, such as a personal computer (PC), a tablet PC, a set-top box (STB), a personal digital assistant (PDA), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 200 can be implemented using electronic devices that provide voice, video or data communication. Further, while a single computer system 200 is illustrated, the term “system” shall also be taken to include any collection of systems or sub-systems that individually or jointly execute a set, or multiple sets, of instructions to perform one or more computer functions.

As illustrated in FIG. 2, the computer system 200 may include a processor 202, e.g., a central processing unit (CPU), a graphics processing unit (GPU), or both. Moreover, the computer system 200 can include a main memory 204 and a static memory 206 that can communicate with each other via a bus 208. As shown, the computer system 200 may further include a video display unit 210, such as a liquid crystal display (LCD), an organic light emitting diode (OLED), a flat panel display, a solid state display, or a cathode ray tube (CRT). Additionally, the computer system 200 may include an input device 212, such as a keyboard, and a cursor control device 214, such as a mouse. The computer system 200 can also include a disk drive unit 216, a signal generation device 218, such as a speaker or remote control, and a network interface device 220.

In a particular embodiment, as depicted in FIG. 3, the disk drive unit 216 may include a computer-readable medium 222 in which one or more sets of instructions 224, e.g. software, can be embedded. Further, the instructions 224 may embody one or more of the methods or logic as described herein. In a particular embodiment, the instructions 224 may reside completely, or at least partially, within the main memory 204, the static memory 206, and/or within the processor 202 during execution by the computer system 200. The main memory 204 and the processor 202 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 224 or receives and executes instructions 224 responsive to a propagated signal, so that a device connected to a network 226 can communicate voice, video or data over the network 226. Further, the instructions 224 may be transmitted or received over the network 226 via the network interface device 220.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used on financial exchanges, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

Although only a few exemplary embodiments of the present invention have been described herein, those skilled in the art will readily appreciate that numerous modifications to the exemplary embodiments are possible without materially departing from the novel teachings and advantages of this invention. It is therefore intended that the foregoing detailed description be regarded as illustrative rather than limiting, and that it be understood that the following claims, including all equivalents, are intended to define the spirit and scope of this invention.

We claim:

1. A computer-readable memory containing processor executable program instructions for creating a benchmark index (XXX) comprising:
obtaining gross daily rates of return of a covered stock index portfolio since an inception date;
multiplying a cumulative product of the gross daily rates of return of the covered stock index portfolio since the inception date by a multiplier; and
wherein a value of the benchmark index is calculated according to the formula:
XXXₜ=XXXₜ₋₁(1+Rₜ)
where Rₜ is a daily rate of return of the covered stock index portfolio, the daily rate of return including ordinary cash dividends paid on component stocks of the index that trade ex-dividend on a date.

2. The computer-readable memory according to claim 1, wherein the daily rate of return of the covered stock index portfolio on a non-roll date is calculated according to the formula:
1+Rₜ=(Sₜ+Divₜ−Cₜ)/(Sₜ₋₁−Cₜ₋₁)
where Sₜ is a closing value of a stock index at date t, Divₜ represents ordinary cash dividends payable on component stocks of the stock index that trade ex-dividend at date t expressed in index points, Cₜ is an arithmetic average of last bid and ask prices of a call option, Sₜ₋₁ is a closing value of the stock index on a preceding trading day and Cₜ₋₁ is an average of last bid and ask prices of the call option reported on the preceding trading day.

3. The computer-readable memory according to claim 1, wherein on a roll date, a gross daily rate of return is compounded from three gross rates of return and calculated according to the formula:
1+Rₜ=(1+Rₐ)×(1+R_{b})×(1+R_{c})
where:
1+Rₐ=(S^{SOQ}+Divₜ−C_{Settle})/(Sₜ₋₁−Cₜ₋₁);
1+R_{b}=(S^{VWAP})/(S^{SOQ}); and
1+R_{c}=(Sₜ−Cₜ)/(S^{VWAP}−C_{VWAP})
where Rₐ is a rate of return of the covered stock index portfolio from a previous close of trading through a first time period, S^{SOQ} is a Special Opening Quotation of the S&P 500, Divₜ represents dividends on index component stocks, C_{Settle} is a final settlement price of an expiring call option (C_{Settle}=Max[0, SOQ−K], where K is the strike price);
where R_{b} is a rate of return of an un-covered stock index portfolio from the first time period to a second time period, S^{VWAP} is a VWAP of the stock index based on substantially similar time and weights used to calculate the VWAP in a new call option; and
where R_{c} is a rate of return of the covered stock index portfolio from the second time period to a close of trading on the roll date, C_{VWAP} is a volume-weighted average trading price of a new call option, and Cₜ is an average bid/ask quote of a new call option reported before a third time period on the roll date.

4. A computer-readable memory containing processor executable program instructions for creating a benchmark index (YYY) comprising:
obtaining gross daily rates of return of a put protected stock index portfolio since an inception date;
multiplying a cumulative product of the gross daily rates of return of the put protected stock index portfolio since the inception date by a multiplier; and
wherein a value of the benchmark index is calculated according to the formula:
YYYₜ=YYYₜ₋₁(1+Rₜ)
where Rₜ is a daily rate of return of the put protected stock index portfolio, the daily rate of return including ordinary cash dividends paid on component stocks of the benchmark index that trade ex-dividend on a date.

5. The computer-readable memory according to claim 4, wherein the daily rate of return of the put protected stock index portfolio on a non-roll date is calculated according to the formula:
1+Rₜ=(Sₜ+Divₜ+Pₜ)/(Sₜ₋₁+Pₜ₋₁)
where Sₜ is a closing value of the stock index at date t, Divₜ represents ordinary cash dividends payable on component stocks of the stock index that trade ex-dividend at date t expressed in index points, Pₜ is an arithmetic average of last bid and ask prices of a put option, Sₜ₋₁ is a closing value of the stock index on a preceding trading day and Pₜ₋₁ is an average of the last bid and ask prices of the put option reported on the preceding trading day.

6. The computer-readable memory according to claim 4, wherein on a roll date, a gross daily rate of return is compounded from three gross rates of return and calculated according to the formula:
1+Rₜ=(1+Rₐ)×(1+R_{b})×(1+R_{c})
where:
1+Rₐ=(S^{SOQ}+Divₜ+P_{Settle})/(Sₜ₋₁+Pₜ₋₁);
1+R_{b}=(S^{VWAP})/(S^{SOQ}); and
1+R_{c}=(Sₜ+Pₜ)/(S^{VWAP}+P_{VWAP})
where Rₐ is a rate of return of the put protected stock index portfolio from a previous close of trading through a settlement of an expiring put option, S^{SOQ} is a Special Opening Quotation used in determining a settlement price of the expiring put option, Divₜ represents dividends on index component stocks, and P_{Settle} is a final settlement price of an expiring put option (P_{Settle}=Max[0, K−SOQ], where K is the strike price);
R_{b} is a rate of return of a non-protected stock index portfolio from the settlement of the expiring option to a time a new put option is deemed bought, S^{VWAP} is the VWAP of the stock index based on substantially similar time and weights used to calculate the VWAP in a new put option; and
R_{c} is a rate of return of the covered stock index portfolio from a time a new put option is deemed sold to a close of trading on the roll date, P_{VWAP} is a volume-weighted average trading price of the new put option between a first time period and a second time period, and Cₜ is an average bid/ask quote of the new put option reported before a third time period.

7. A computer-readable memory containing processor executable program instructions for creating a benchmark index (ZZZ) comprising:
obtaining gross daily rates of return of a collared stock index portfolio since an inception date;
multiplying a cumulative product of the gross daily rates of return of the collared stock index portfolio since the inception date by a multiplier; and
wherein a value of the benchmark index is calculated according to the formula:
ZZZₜ=ZZZₜ₋₁(1+Rₜ)
where Rₜ is a daily rate of return of a collared stock index portfolio, a daily rate of return including ordinary cash dividends paid on component stocks of a stock index that trade ex-dividend on a date.

8. The computer-readable memory according to claim 7, wherein the daily rate of return of the collared stock index portfolio on a non-roll date is calculated according to the formula:
1+Rₜ=(Sₜ+Divₜ+Pₜ−Cₜ)/(Sₜ₋₁+Pₜ₋₁−Cₜ₋₁)
where Sₜ is a closing value of the stock index at date t, Divₜ represents an ordinary cash dividends payable on component stocks of the stock index that trade ex-dividend at date t expressed in index points, Pₜ and Cₜ are arithmetic averages of last bid and ask prices of put and call options, respectively, reported before a first time period on date t, Sₜ₋₁ is a closing value of the stock index on a preceding trading day and Pₜ₋₁ and Cₜ₋₁ are averages of the last bid and ask prices of the put and call options, respectively, reported before a second time period on the preceding trading day.

9. The computer-readable memory according to claim 7, wherein on a roll date, a gross daily rate of return is compounded from three gross rates of return and calculated according to the formula:
1+Rₜ=(1+Rₐ)×(1+R_{b})×(1+R_{c})
where:
1+Rₐ=(S^{SOQ}+Divₜ+P_{Settle}−Cₛₑₜₜₗₑ)/(Sₜ₋₁+Pₜ₋₁−Cₜ₋₁);
1+R_{b}=(S^{VWAP})/(S^{SOQ}); and
1+R_{c}=(Sₜ+Pₜ−Cₜ)/(S^{VWAP}+P_{VWAP}−C_{VWAP})
where Rₐ is a rate of return of the collared stock index portfolio from a previous close of trading to a first time period, S^{SOQ} is a Special Opening Quotation of the S&P 500, Divₜ represents dividends on index component stocks, Pₛₑₜₜₗₑ and C_{Settle} are final settlement prices of the expiring put and call options, respectively, (P_{Settle}=Max[0, K−SOQ], and Cₛₑₜₜₗₑ=Max[0, SOQ−K] where K is the strike price);
R_{b} is a rate of return of the stock index portfolio from a settlement of an expiring option to a time new put and call options are deemed bought and sold, S^{VWAP} is a volume-weighted average value of the stock index based on substantially similar time and weights used to calculate a VWAP in new call and put options.
R_{c} is a rate of return of the collared stock index portfolio from a time the new put and call options are deemed bought and sold to a close of trading on the roll date, S^{VWAP} is a volume-weighted average value of the stock index based on combined times and volumes used to calculate the VWAP of the new put and call options, P_{VWAP} and C_{vwap} are the VWAPs of the new put and call options between a second time period and a third time period and Pₜ and Cₜ are average bid/ask quotes of the new put and call options reported before a fourth time period.

10. A system for creating and trading derivatives based on a benchmark index of an underlying covered stock index portfolio, comprising:
a benchmark index module comprising a first processor, a first memory coupled with the first processor, and a first communications interface coupled with a communications network, the first processor, and the first memory;
a dissemination module coupled with the benchmark index module, the dissemination module comprising a second processor, a second memory coupled with the second processor, and a second communications interface coupled with the communications network, the second processor, and the second memory;
a first set of logic, stored in the first memory and executable by the first processor to receive current values for an underlying stock index of a covered stock index portfolio benchmark derivative through the first communications interface, calculate a benchmark value for the underlying covered stock index portfolio, and pass the value for the calculated benchmark to the dissemination module; and
a second set of logic, stored in the second memory and executable by the second processor to receive the calculated benchmark value for the underlying covered stock index portfolio from the benchmark index module, and disseminate the calculated benchmark value through the second communications interface to at least one market participant.
